(19) United States
(12) Patent Application Publication
(10) Pub. No.: US 2020/0402497 A1
(43) Pub. Date: Dec. 24, 2020

(54) Systems and Methods for Speech Generation

(71) Applicant: Replicant Solutions, Inc., San Francisco, CA (US)

(72) Inventors: Zak Semenov, Toronto (CA); John Meade, Kitchener (CA); Alessandro Marin, Waterford (CA); Alexander L. De Souza, Leiden (NL); Benjamin Gleitzman, Alameda, CA (US); Meghna Suresh, San Francisco, CA (US)

(73) Assignee: Replicant Solutions, Inc., San Francisco, CA (US)

(21) Appl. No.: 16/911,314

(22) Filed: Jun. 24, 2020

Related U.S. Application Data
(60) Provisional application No. 62/865,772, filed on Jun. 24, 2019.

(51) Int. Cl. G10L 13/10; G10L 13/04; G10L 19/16; G10L 21/0332; G06N 3/08

(52) U.S. Cl. CPC G10L 13/10; G10L 13/04; G06N 3/08; G10L 21/0332; G10L 19/167

(57) ABSTRACT

Systems and methods for generating audio data in accordance with embodiments of the invention are illustrated. One embodiment includes a method for generating audio data. The method includes steps for generating a plurality of style tokens from a set of audio inputs, generating an input feature vector based on the plurality of style tokens and a set of text features, and generating audio data (e.g., a spectrogram, audio waveforms, etc.) based on the input feature vector.

### CROSS-REFERENCE

The present application claims priority to U.S. Provisional Application No. 62/865,772, entitled “Systems and Methods for Speech Generation”, filed Jun. 24, 2019, the disclosure of which is incorporated herein by reference in its entirety.

### FIELD OF THE INVENTION

The present invention generally relates to voice generation and, more specifically, to a system that uses a convolutional neural network to generate speech and/or audio data.

### BACKGROUND

Voice interactions with computers have greatly increased over the past few years. Generating voices has been used in a variety of different applications ranging from smart assistants to synthetic voices for people unable to speak on their own. Various methods for generating artificial voices have been developed, but it has been difficult to produce realistic and stylized voices in an efficient manner.

### SUMMARY OF THE INVENTION

Systems and methods for generating audio data in accordance with embodiments of the invention are illustrated. One embodiment includes a method for generating audio data. The method includes steps for generating a plurality of style tokens from a set of audio inputs, generating an input feature vector based on the plurality of style tokens and a set of text features, and generating audio data (e.g., a spectrogram, audio waveforms, etc.) based on the input feature vector.

In a further embodiment, generating the plurality of style tokens comprises generating a speaker token using a speaker subnetwork, and generating a prosody token using a prosody subnetwork.

In still another embodiment, at least one of the speaker subnetwork and the prosody subnetwork is a pre-trained network.

In a still further embodiment, the set of audio inputs includes a set of samples with a desired characteristic, wherein the generated audio data reflects the desired characteristic.

In yet another embodiment, generating the input feature vector includes at least one of averaging, concatenating, and adding a subset of the plurality of style tokens.

In a yet further embodiment, the set of text features includes at least one of raw text, audio data, parts of speech, and phonemes.

In another additional embodiment, generating the audio data includes utilizing a convolution neural network (CNN) to generate a spectrogram.

In a further additional embodiment, generating the audio data includes utilizing teacher and student networks to generate the audio data.

In another embodiment again, generating the audio data comprises training the teacher network to generate audio data in an autoregressive manner, and training the student network to learn from the teacher network to generate audio data in a non-autoregressive manner.

In a further embodiment again, training the student network includes training the student network to learn to predict attention from the set of audio inputs, wherein the student network generates the audio data using the predicted attention.

In still yet another embodiment, the generated audio data is a mel spectrogram.

In a still yet further embodiment, the method further includes generating audio waveforms from the generated spectrogram.

One embodiment includes a non-transitory machine readable medium containing processor instructions for generating audio data, where execution of the instructions by a processor causes the processor to perform a process that comprises generating several style tokens from a set of audio inputs, generating an input feature vector based on the several style tokens and a set of text features, and generating audio data based on the input feature vector.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates an example of a speech generation framework in accordance with an embodiment of the invention.

FIG. 2 illustrates an example of a speech generation framework with a teacher-student network in accordance with an embodiment of the invention.

FIG. 3 illustrates an example of an audio data generation engine that uses convolutional neural networks (CNNs).

FIG. 4 conceptually illustrates a process for training a speech generation framework in accordance with an embodiment of the invention.

FIG. 5 conceptually illustrates a process for training an audio data generation engine in accordance with an embodiment of the invention.

FIG. 6 conceptually illustrates a process for training a teacher-student audio data generation engine in accordance with an embodiment of the invention.

FIG. 7 illustrates an example of mini-batching for triplet loss in accordance with an embodiment of the invention.

FIG. 8 conceptually illustrates a process for generating audio data for speech generation in accordance with an embodiment of the invention.

FIG. 9 conceptually illustrates a process for autoregressively generating audio data in accordance with an embodiment of the invention.

FIG. 10 conceptually illustrates a process for generating audio data in a non-autoregressive manner in accordance with an embodiment of the invention.

FIG. 11 conceptually illustrates a process for generating audio data using a student-teacher network in accordance with an embodiment of the invention.

FIG. 12 illustrates an example of a speech generation system in accordance with an embodiment of the invention.

FIG. 13 illustrates an example of a speech generation element in accordance with an embodiment of the invention.

### DETAILED DESCRIPTION

Turning now the drawings, systems and methods in accordance with numerous embodiments of the invention can be used to generate audio (e.g., voices, speech) with various characteristics. In certain embodiments, audio of a speaker(s) can be passed through a number of style subnetworks (e.g., speaker, prosody, etc.) to generate tokens. Prosody subnetworks in accordance with many embodiments of the invention can be used to classify or extract the prosody to produce a prosody token from an input audio. In several embodiments, prosody subnetworks can implement various methods for extracting prosody, including (but not limited to) global style tokens (GST). In numerous embodiments, style tokens, along with a set of text, can be passed into an audio data generation engine (such as, but not limited to a CNN (or distributed across multiple CNNs), and/or teacher-student networks) to generate audio data, such as, but not limited to, spectrograms, audio waveforms, etc. Spectrograms in accordance with several embodiments of the invention can be converted to audio waveforms using a variety of methods and models, including (but not limited to) spectrogram inversion and CNNs.

In some known methods, characteristic features of the data can be treated as knobs that can be turned. For instance, if a multi-speaker corpus was used, two clusters may be present in the training data, one corresponding to males and the other to females. Since there are two present clusters, existing models can suggest a “knob to turn” i.e., turning towards the male cluster centroid or turning towards the female cluster centroid. Using these knobs, a voice can be selected. Passing an audio sample through such an encoder and then conditioning inference on that token would then enable one shot learning of a voice.

Models in accordance with certain embodiments of the invention can implicitly have clusters (e.g., of male and female). Rather than exposing a “knob” (e.g., male and female), processes in accordance with numerous embodiments of the invention can take a sample of voices with a desired characteristic in order to generate a voice with the desired characteristic. For example, in order to achieve more male-like qualities, processes in accordance with a variety of embodiments of the invention can take a sample of N male voices, obtain each of their tokens, and aggregate them. The aggregated tokens can then be used to generate audio with characteristics of the aggregated tokens. Such an axis would correspond to an axis that has characteristic male features. Taking some epsilon small step from an initial voice down this male axis would impart more of a “manly” voice to it.

Another benefit of systems and methods in accordance with numerous embodiments of the invention is in the embedding space. Some models try to take a multi speaker corpus and cluster different characteristics together, creating a latent space with N distinct clusters, depending on the parameter (number of knobs) that are exposed. Indeed, at some level, as the number of knobs on which the model is conditioned increases, the latent space of the voices would start to resemble a vine of grapes. On the contrary, voice embeddings in accordance with numerous embodiments of the invention can enforce a constraint putting all of the voices on points on a high dimensional sphere. Although this does not directly expose knobs to turn, it attempts to make the manifold smooth and provides a guarantee that all points on this sphere will correspond to a voice. In other methods, one could imagine taking the most “manly” voice in the set and turning the male knob further. It could then make a voice it is not able to utter, whereas models in accordance with certain embodiments of the invention can be resilient towards epsilon steps in any direction.

### Speech Generation Framework

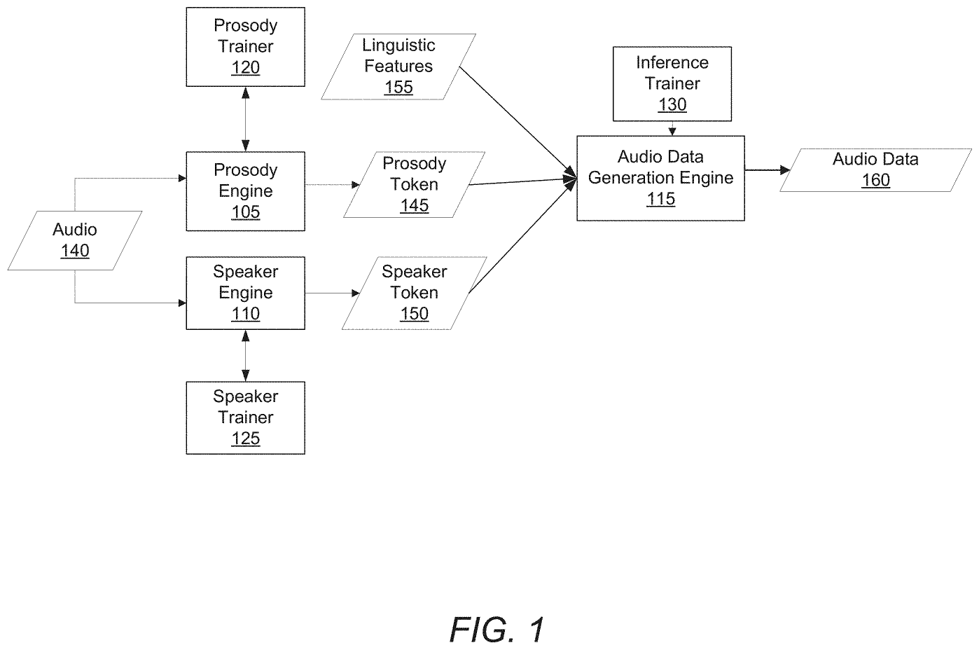

Speech generation frameworks in accordance with many embodiments of the invention can include various elements to generate realistic and varied voices. An example of a speech generation framework in accordance with an embodiment of the invention is illustrated in FIG. 1. Speech generation framework 100 includes prosody engine 105, speaker engine 110, and inference module 115. Input audio 140 can be passed through prosody engine 105 and speaker engine 110 to generate prosody token 145 and speaker token 150 respectively. Text features 155 can be passed, along with the speaker and prosody tokens, through inference module 115 to generate audio data 160.

In this example, speech generation framework 100 also includes prosody trainer 120, speaker trainer 125, and inference trainer 130. Although each of the prosody engine, speaker engine, and inference module are shown with separate trainers, speech generation frameworks in accordance with a variety of embodiments of the invention can use pre-trained engines that do not require a trainer and/or can include a master trainer for training the overall network. Trainers in accordance with several embodiments of the invention can include various elements including (but not limited to) adversarial networks, audio data generation engines, automatic speech recognition elements, and/or loss computation engines. Loss computation engines can compute a variety of different types of loss including (but not limited to) ASR loss, spectrogram loss, triplet loss, cyclic embedding loss, and a custom loss.

In various embodiments, speech generation frameworks include a number of style subnetworks for analyzing a set of inputs and for generating outputs (e.g., tokens) that reflect particular features of the inputs. In a number of embodiments, each style subnetwork is trained to identify different features of the input that can be applied to an output voice. In the same way that a human is able to distinguish both who is speaking and the tone in which they are speaking, speech generation frameworks in accordance with numerous embodiments of the invention can include a speaker subnetwork and/or a prosody subnetwork to generate prosody and style tokens from each audio input. In several embodiments, style subnetworks can be partially trained independently to ensure that each network is primed to pay attention to their corresponding features. In this manner, style gradients at later stages can flow most freely through the style subnetwork.

Speaker subnetworks in accordance with several embodiments of the invention can generate voice embedding hyperspheres that define a latent space of voices. In many embodiments, tokens of a speaker subnetwork can be visualized on a hypersphere by embedding them into an ‘n+1’ dimensional space and then restricting one degree of freedom by forcing them to be points on a sphere (e.g., parameterizing a hypersphere). Voice embedding hyperspheres in accordance with numerous embodiments of the invention can be initially trained separately to encourage it to find its own optima. In several embodiments, after a speaker network (or an embedding model) shows signs of convergence, it can be added to a larger speech generation framework (or network). The weights of style (or embedding) subnetworks in accordance with several embodiments of the invention can be trained during audio data generation training to allow the global model to refine the embeddings as needed.

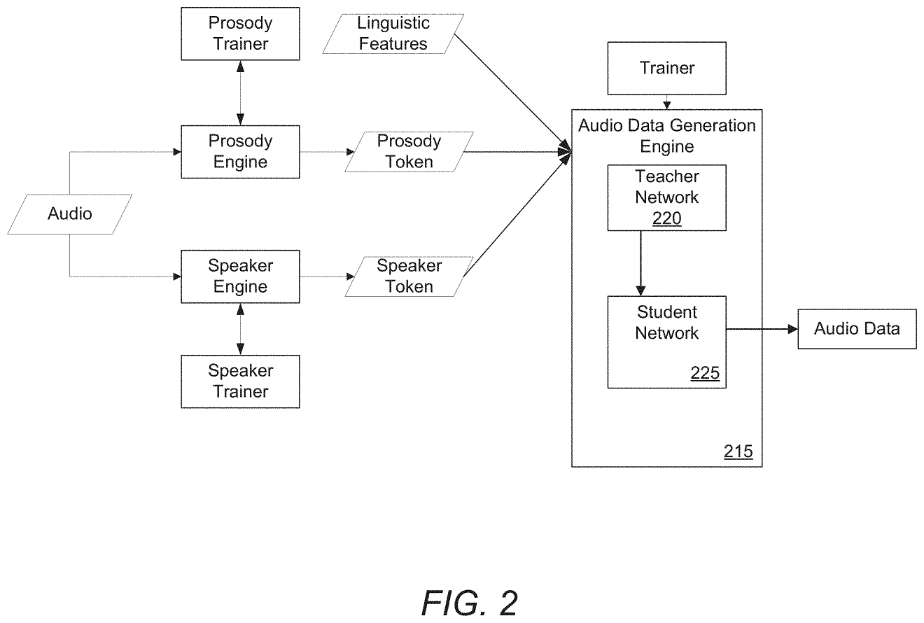

Inference modules (or audio data generation engines) in accordance with some embodiments of the invention can generate audio data using a CNN and/or a student teacher network with normalizing loss. Audio data in accordance with some embodiments of the invention can include (but is not limited to) spectrograms, audio waveforms, and other representations of audio. An example of a speech generation framework where the inference module is a teacher-student network is illustrated in FIG. 2. In this example, the inference module 215 is an audio data generation engine with a teacher network 220 and a student network 225. In various embodiments, teacher networks can learn to autoregressively generate attention, and student networks can learn to determine attention from a teacher network to generate audio data in a non-autoregressive manner. Student networks in accordance with several embodiments of the invention can perform flow normalization to learn the distribution of a teacher network to generate audio data. Audio data generation with CNNs and teacher/student networks are described in further detail below.

### Convolutional Neural Networks (CNNs)

In a number of embodiments, speech generation frameworks include an audio data generation engine for generating audio data (e.g., spectrograms, audio waveforms, etc.) based on a number of inputs (e.g., text features, prosody tokens, speaker tokens, etc.). In related works, text to mel networks have often had an autoregressive property, where a single audio frame was generated at a time, and each audio frame was conditioned on all the past frames. Concretely, to generate the Nth frame of audio in a sample, it would condition the model on all the (N−1) frames of generated audio. For a 20 second audio clip, the network must be sampled 20 times, each time taking longer than the past. In practice, the sampling rate is much greater than once per second, perhaps even going up to 45,000 samples per second for high fidelity data. As the samples increase, inference becomes increasingly slow. Networks that attempt to produce the audio all in one go cannot learn the natural flow required for speech frames to be continuous, fluid and legible.

In a variety of embodiments, audio data generation can be performed using a set of one or more convolutional neural networks (CNNs). Unlike other related works, which have traditionally used CNNs to turn a spectrogram into a waveform, processes in accordance with a variety of embodiments of the invention can use CNNs to generate the spectrogram itself.

In several embodiments, processes can use CNNs to convert text features and style inputs into mel spectrograms that include vocal and/or speaker characteristics. CNNs in accordance with certain embodiments of the invention can take as input text features (e.g., raw text, audio data, parts of speech, phonemes, etc.) and style tokens (e.g., speaker and/or prosody tokens) to produce a spectrogram. In a number of embodiments, text features can include positional encoding (e.g., triangular positional encoding) to indicate the notion of time. Text features in accordance with a variety of embodiments of the invention can be generated using machine learning models, such as (but not limited to) convolutional neural networks (CNNs), recurrent neural networks (RNNs), and long short-term memory (LSTM) networks. In order to train the audio data CNNs, processes in accordance with numerous embodiments of the invention can take ground truth spectrograms (causal+autoregressive) as input.

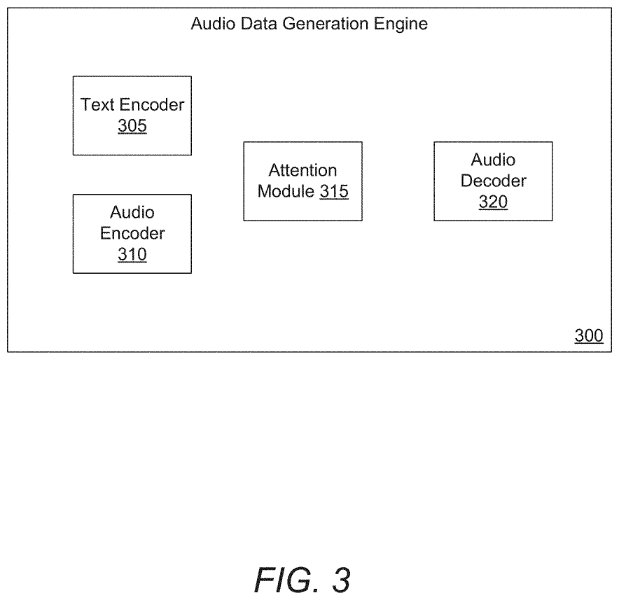

An example of an audio data generation engine is illustrated in FIG. 3. In this example, audio data generation engine 300 includes a text encoder 305, audio encoder 310, attention module 315, and audio decoder 320. Encoders and decoders in accordance with various embodiments of the invention can include a learned model, such as (but not limited to) a convolutional neural network. Attention modules in accordance with several embodiments of the invention can be used to focus the weights of the inputs in the generation of audio by an audio decoder.

In many embodiments, audio data generation engines can be used to autoregressively generate frames of audio (e.g., spectrograms, waveforms, and/or other audio data) based on a set of text features, style tokens, and/or previously generated frames. In several embodiments, linguistic features can be generated from text features and/or style tokens in order to generate audio frames. As audio frames are generated, the generated audio can be fed through an audio encoder, which generates encodings of the audio generated thus far. Audio encodings can then be used in conjunction with linguistic features to generate attention (e.g., through an attention module) to direct the generation of a subsequent frame.

Text encoders in accordance with some embodiments of the invention can be used to analyze input text features to generate linguistic features. In a variety of embodiments, text encoders can take text features as input to generate an encoding of the text. Text encoders in accordance with some embodiments of the invention can be used to generate feature vectors that map input text features to features in a latent space. In some embodiments, text encoders can be used to generate a plurality of feature vectors (or portions of a single vector) that can be used as a key and value. The key and value vectors in accordance with many embodiments of the invention can be used along with an audio encoding of previous audio (e.g., from an audio encoder) for determining attention during audio data generation. In several embodiments, text encoders can be trained to further generate a query vector for the input text features instead of autoregressively using audio encodings, allowing for non-autoregressive generation of audio data.

Audio encoders in accordance with a variety of embodiments of the invention can encode audio data of previously spoken speech. Audio encoders in accordance with some embodiments of the invention can be used to generate a feature vector that maps the input text features to features in a latent space. In certain embodiments, audio encoders can be used to encode audio data of a first duration of audio (e.g., a number of frames) that can be used in conjunction with key and value vectors from a text encoder to determine attention for a next subsequent portion of the audio data that is to be generated.

Attention evaluates how strongly each portion of the input text features correlate with a set of one or more frames of the output. In a variety of embodiments, the relationship between text and the generated audio data can be directed based on an attention mechanism. In many embodiments, attention modules can be used to weight a relationship between input text features and previously generated audio to determine an attention mechanism that can be used to generate subsequent audio frames. Attention modules in accordance with a variety of embodiments of the invention can generate attention matrices based on input linguistic features and/or style tokens in conjunction with encodings of previously uttered audio. In various embodiments, attention can be enforced to be a monotonically decreasing line. Attention in accordance with many embodiments of the invention can be allowed to roughly flatline during pauses or at the end of a statement.

In several embodiments, attention masks are calculated and a Gaussian decay function are used. In some embodiments, rather than approximately biasing the attention to a diagonal, processes can directly predict fertility values from the text features directly. Knowing how ‘fertile’ a given feature is in text encoder output can allow processes to copy that feature however many times it ought to be repeated to align directly with the mel frames. Using these fertility values directly, processes in accordance with many embodiments of the invention can compute a more exact attention mask, which allows for better alignment of the model and for a system to naturally speak the most complex tongue twisters.

Audio decoders in accordance with numerous embodiments of the invention can be used to synthesize audio data from the resulting attention matrix. In a variety of embodiments, audio decoders can generate audio data one frame at a time. Alternatively, or conjunctively, audio decoders in accordance with a variety of embodiments of the invention can be used to synthesize all of the frames for a given duration in a single pass. Once a spectrogram has been generated, processes in accordance with a number of embodiments of the invention can use traditional methods to transform spectrograms into audio waveforms.

CNNs in accordance with some embodiments of the invention are further described in “Efficiently Trainable Text-to-Speech System Based on Deep Convolutional Networks with Guided Attention” by Tachibana, et al., the disclosure from which relevant to the use of CNNs for spectrogram generation is hereby incorporated by reference in its entirety.

Although a specific example of a regressive speech generation element is illustrated in FIG. 3, any of a variety of speech generation elements can be utilized to perform processes for speech generation similar to those described herein as appropriate to the requirements of specific applications in accordance with embodiments of the invention. For example, speech generation elements in accordance with numerous embodiments of the invention can implement teacher-student networks to learn attention and to perform non-autoregressive speech generation.

### Attention Teacher Student Networks

Many text-to-speech (TTS) models are autoregressive, meaning that a model generates a single frame of audio at a time, and, with each subsequent frame, it would condition the next frame on all the past frames. Concretely, to generate the Nth frame of audio, an autoregressive model would be conditioned on all the previous (N−1) frames. In some embodiments, such previous frames would then be fed into an audio encoder (as described in this application) to yield an encoding Q so that the model could generate the next frame picking up where it left off. Including all of the N−1 frames would be necessary to model longer term audio dependencies and to ensure that consistent tone was present. With all of this past audio information, generating the Nth frame can use and build upon information from the past frames allowing it to sound more natural when modelling long term information, such as for inflection at the end of a question. The downside of this is that each frame is dependent on its past frames, so no parallelism can be achieved (resulting in slow inference times) and there is a linear increase in data which needs to be processed at each frame. This has the unfortunate effect of making the 100th frame significantly slower to generate than the 10th as there is 10× more data that it needs to condition on.

Spectrogram generation engines in accordance with many embodiments of the invention can use non-autoregressive (NAR) methods to generate audio, allowing for significantly faster inference and generation of audio. Formally, if the output audio is n frames long, the autoregressive (AR) model is O(n\hat{ }2) where as the NAR model is O(n).

In many embodiments, NAR systems can use an attention teacher student pair, in which a teacher network is trained to autoregressively learn to predict attention, and a corresponding student network is trained to predict attention matrices based on only the text features in a non-autoregressive manner. Using this architecture with the above attention allows processes in accordance with certain embodiments of the invention to generate all the frames in parallel, resulting in performance that is orders of magnitude faster than were previously possible. In order to achieve realtime conversation constraints, processes in accordance with various embodiments of the invention, can explicitly predict all of the frames at once, instead of one at a time. Other NAR systems can often introduce attention deficits such as mumbles, stutters and skips. In addition, by generating all of the frames at once, it can be difficult for such a model to model long term dependencies and may tend to exponentially degrade quality with time.

Systems and methods in accordance with numerous embodiments of the invention provide non-flow-based attention knowledge distillation using a teacher student pair to learn explicit attention values. In a number of embodiments, teacher networks can have architectures similar to those described with reference to FIG. 3. Student networks in accordance with some embodiments of the invention can have similar architectures, but may not include an audio encoder, as the attention for the student network is learned from the teach network and can be generated directly from text features. With attention knowledge distillation, all of the frames can be predicted at once. Processes in accordance with a variety of embodiments of the invention can learn an approximate Q, as the attention would only be useful if the queries can be generated from the already uttered audio. In some embodiments, queries can be efficiently estimated using only the input text stream. As a result, text encoders can be augmented to output K, V and Q. In some such embodiments, an audio data generation engine may not employ an audio encoder at all.

In knowledge distillation, teachers in accordance with some embodiments of the invention can be trained until convergence using an approximate attention loss based on predicted K, V, and Q. After convergence, the attention from the teacher model can be smoothed of any glitches, and this attention can then be treated as ground truth. Students of such a teacher can be trained using this as the exact attention loss target. When such K, V, Q are used with attention schemes trained only on the exact attention values from a fully converged teacher, processes in accordance with numerous embodiments of the invention can build a model that intrinsically knows what features to utter when (as all the information was derived from the fixed text sequence). In numerous embodiments, audio data generation engines can generate all of the mel frames all at once non-autoregressively. Such processes can provide orders of magnitude speedup over previous models. Further, the attention is often more stable and yields fewer mispronunciations in practice.

### Normalizing Flow

Audio data generation engines in accordance with a number of embodiments of the invention can include a teacher network and student network. In a variety of embodiments, the structure of teacher networks can be basically the same as a CNN network for generating audio data. However, in many embodiments, the output is not a spectrogram, but instead are the parameters to a probability density function over a space of spectrograms.

Teacher networks in accordance with numerous embodiments of the invention can teach a student network a probability distribution over a latent space, such that the student network can learn to internalize this distribution and then output samples that would fit the teacher's distribution. Processes in accordance with certain embodiments of the invention can train up a teacher network that generates audio one frame at a time, and can train a student network to generate all the audio in a single pass. In some embodiments, the student network can be conditioned to approximate and internalize the autoregressive distribution that the teacher network has learned. This has the effect of learning enunciation from the autoregressive network in a single pass, rather than causally and sequentially. This can allow speech to be generated far faster than conversational constraints on a traditional CPU.

Student networks in accordance with some embodiments of the invention can include a normalizing flow for learning the spectrogram distribution of a teacher network. In some embodiments, normalizing flows can transform samples between a well known distribution (e.g., normal, logistic, etc) and a spectrogram distribution of the teacher network.

Teacher and student networks in accordance with various embodiments of the invention can be trained using a set of one or more losses (e.g., a density divergence measure, such as (but not limited to) a Kullback-Leibler divergence). The richness of information in the density function (as opposed to a simple direct prediction) is what allows the student to learn what the standard network could not.

### Processes for Speech Generation

### Training

In various embodiments, a speaker, prosody, and inference module (or audio data generation engine) are all trained in tandem, since each module will have a “separation of concerns” via the loss functions. In many embodiments, each subnet is pretrained individually, prior to training as a part of the larger network, so that when they are combined and are trained in the larger network, each subnetwork already has rich features, which encourages efficient backpropagation of losses to each subnetwork. For example, by using a pretrained prosody subnetwork, the prosody subnetwork already has rich prosody features so that the prosody knowledge accumulated in the large network is best encouraged to backpropagate to the region of the subnet that was initially encouraged to learn prosodic features.

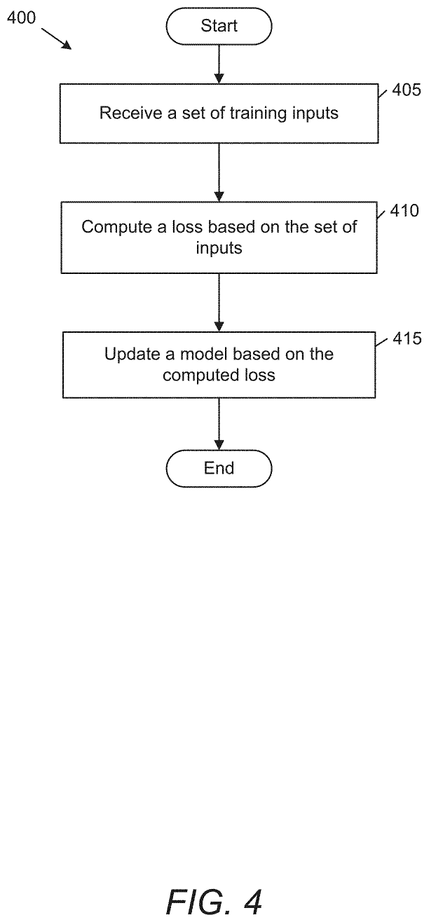

An example of a process for training a speech generation framework in accordance with an embodiment of the invention is illustrated in FIG. 4. Speech generation frameworks in accordance with some embodiments of the invention can be trained as a whole, or in separate parts. For example, processes in accordance with numerous embodiments of the invention can train subnetworks of a speech generation framework prior to, or in parallel with, an inference module for generating audio data. Process 400 receives (405) a set of inputs from a set of training data. In some embodiments, inputs from training data can be selected in minibatches for a triplet loss. Training data in accordance with many embodiments of the invention can include (but is not limited to) ground truth spectrograms, spoken text, audio waveforms, encodings, and/or tokens. Process 400 computes a loss based on the set of inputs. Losses in accordance with a variety of embodiments of the invention can include (but are not limited to) attention loss, cyclic embedding loss, triplet loss, and/or a spectrogram loss. Process 400 can then update (415) a model based on the computed loss. Models in accordance with several embodiments of the invention can include one or more parts of a speech generation framework, such as (but not limited to) style token generation, spectrogram generation, and/or waveform generation. Updating the model in accordance with many embodiments of the invention can include backpropagation of a loss to update weights of a model.

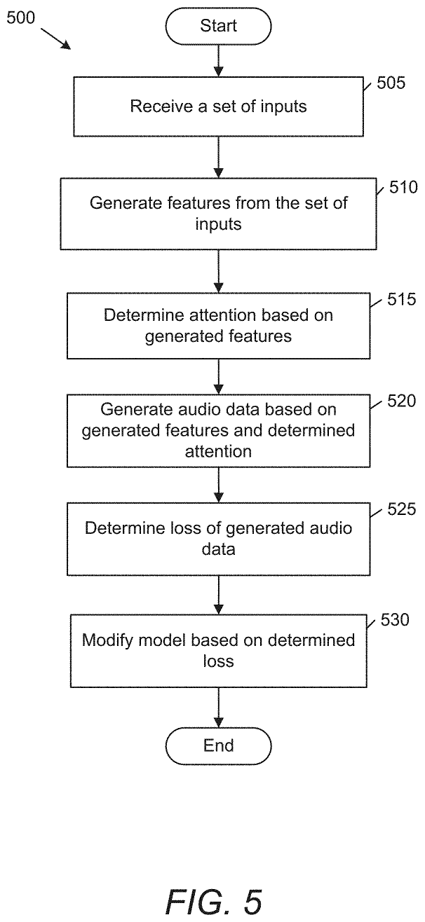

In several embodiments, updating a speech generation framework can include training individual parts of the framework. An example of a process for training an audio data generation engine in accordance with an embodiment of the invention is illustrated in FIG. 5. Process 500 receives (505) a set of inputs. Inputs can include any of a number of text features, such as (but not limited to) ground truth spectrograms, spoken text, audio waveforms, encodings, and/or tokens. Process 500 generates (510) features from the text features of the set of inputs. In various embodiments, generated features can include (but are not limited to) one or more linguistic feature vectors generated by a text encoding model based on the text features. Linguistic features in accordance with many embodiments of the invention can include a key vector, a value vector, and/or a query vector. In certain embodiments, linguistic feature vectors can encode various features of the text including (but not limited to) grammar, meaning, sequences, etc. Process 500 determines (515) attention based on generated features. Attention in accordance with many embodiments of the invention can be used to map the effect of input text features to output audio data across a time dimension. Process 500 generates (520) audio data based on generated features and determined attention. Process 500 determines (525) loss of generated audio data. Loss of the generated audio data in accordance with certain embodiments of the invention can include one or more objective functions that measure the ability of an audio decoder to generate desired audio data. For example, processes in accordance with many embodiments of the invention can determine loss based on an ability of an audio decoder to reproduce “true” audio for a set of text features. Process 500 modifies (530) the model based on the determined loss. Modifying the model in accordance with various embodiments of the invention can include backpropagating the determined loss through one or more of the models of a speech generation framework.

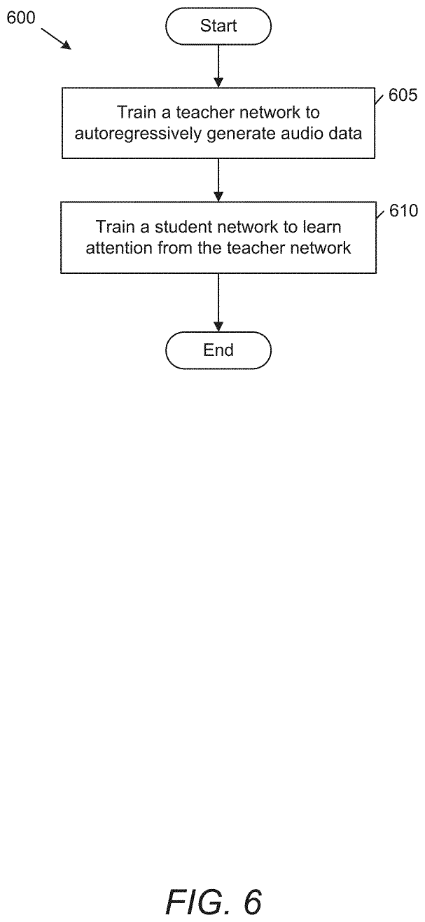

In many embodiments, audio data generation engines can include a teacher-student network. An example of a process for training a teacher-student audio data generation engine in accordance with an embodiment of the invention is illustrated in FIG. 6. Process 600 trains (605) a teacher network to autoregressively generate audio data. Autoregressively generating audio data in accordance with numerous embodiments of the invention can include generating each frame of an output spectrogram based on previously generated frames of the output spectrogram. In numerous embodiments, training teacher networks to generate autoregressively generate audio data can allow the teacher network to learn to determine attention. Process 600 trains (610) a student network to learn attention from the teacher network. Student networks in accordance with a variety of embodiments of the invention can learn an attention distribution from a trained teacher network. In several embodiments, student networks can learn to determine attention based on input text features in a single shot, allowing student networks to generate output audio data in a non-autoregressive manner.

While specific processes for training a speech generation system are described above, any of a variety of processes can be utilized to train systems as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

In many embodiments, training of the different portions of the speech generation framework can use a combination of one or more different loss functions. Training in accordance with some embodiments of the invention can use a different loss for each step of the process, or can aggregate losses from the various portions in order to train them all in one step. In some embodiments, the aggregation of the losses can weight the losses from different portions differently (e.g., mel loss can have a higher weight). Processes in accordance with several embodiments of the invention can use a variety of different loss functions. In a number of embodiments, loss functions can apply softer and harder gradients based on whether a given model is experientially observed the models to struggle. Examples of loss functions in accordance with a variety of embodiments of the invention are described below.

### Triplet Loss

In many embodiments, modules of a speech generation framework can be trained using a triplet loss. In a number of embodiments, triplet loss can be used on the outputs of a speaker embedding network, where the anchor and positive samples are samples spoken from the same speaker and negative samples are samples from a different (but similar sounding) speaker. Triplet loss attempts to take three samples, an anchor, a positive and a negative. The loss is generated to assert that a distance from a positive sample to an anchor sample is smaller than the distance from a negative sample to the anchor sample. Training with a triplet loss attempts to attract similar positive samples and repel negative samples. The embedding space can then shaped by iterations of this push/pull effect. In practice, random negatives are often sampled, but random negatives in high dimensional space are likely to be far away from the positive, such that the repulsion effect of a given negative sample is small. Triplet loss has shown state of the art in facial recognition, but it can be difficult to find negative samples that generate sufficient push/pull forces during training.

Triplet cliques in accordance with many embodiments of the invention have extended triplet (and quadruplet) loss to create minibatches designed to make models converge optimally. Processes in accordance with a variety of embodiments of the invention can select a set of one or more nearest negative examples, from which a model is able to learn the most. In certain embodiments, the nearest negative samples are identified using ball trees in order to efficiently find the nearest negative example. Asserting parity of speaker metadata, this can become a very computationally efficient query, allowing a model to select, for each sample, the data that will allow it to learn the most.

In a number of embodiments, processes can identify minibatches of samples for training. Instead of taking a single anchor sample and a single positive sample, processes in accordance with several embodiments of the invention can take multiple (e.g., five) positive samples for each anchor sample. For each of these positive samples, processes in accordance with various embodiments of the invention can efficiently query a ball tree to find a number (e.g., five) of the closest negative points (i.e., the hardest points to differentiate). In numerous embodiments, these samples make up a minibatch of pathological examples that a model can learn the most on.

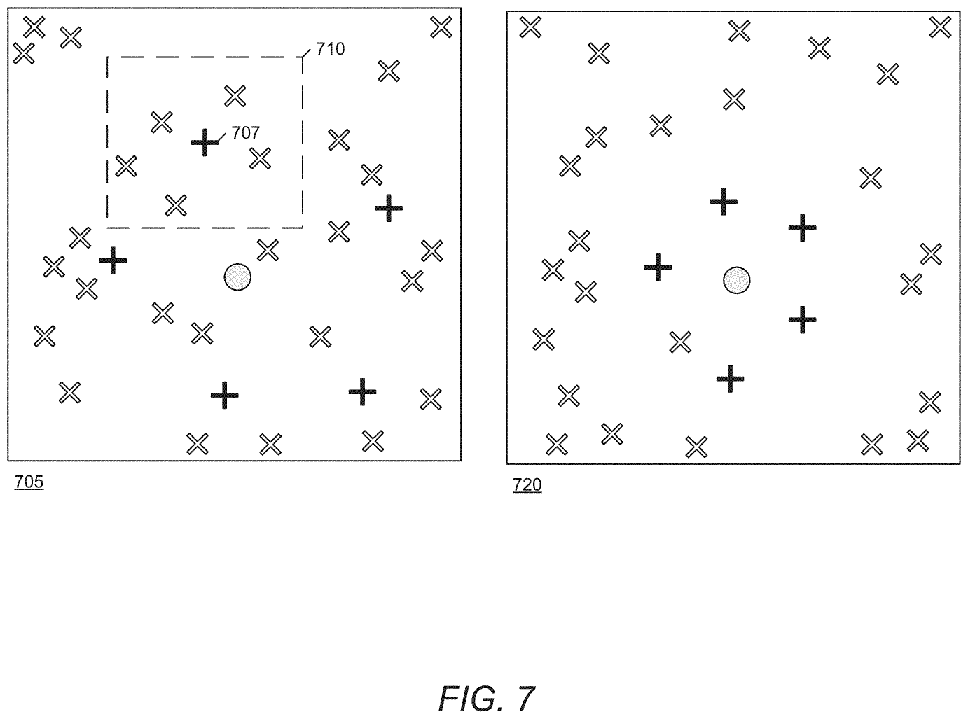

An example of minibatches for triplet loss is illustrated in FIG. 7. The first stage 705 shows an anchor sample (illustrated as a circle), with five surrounding positive samples (illustrated as plus signs). The x marks indicate negative samples. In the first stage 705, the five nearest negative samples of a positive sample 707 are surrounded by a dashed box 710. The second stage 720 illustrates training of a model based on such minibatches can move negative samples further away from the anchor sample, while also pulling positive samples closer.

By selecting N positive samples and M negatives for each anchor sample, a minibatch of ((N+1)choose2)*M samples can be generated in accordance with many embodiments of the invention. Minibatches in accordance with a number of embodiments of the invention not only have the best points from which to learn, but since the samples all belong to the same anchor sample, the optimizer (or training engine) has an effect of pushing all of the positive samples together and repelling from the different negative samples, making the positive cluster a tight clique in embedding space. Triplet losses with triplet cliques in accordance with some embodiments of the invention allow a model to converge to a stable solution in a significantly shorter period of time compared to conventional triplet loss functions.

### Cyclic Embedding

In some embodiments, cyclic embedding losses can be used to train parts of a speech generation framework. Cyclic embedding losses in accordance with several embodiments of the invention can be computed based on a difference between a computed style token and a predicted style token. Processes in accordance with many embodiments of the invention can compute a cyclic embedding loss by computing a style token for an input spectrogram, computing a predicted spectrogram, and then computing a predicted style token based on the predicted spectrogram. Cyclic embedding losses in accordance with a number of embodiments of the invention can then be computed based on a loss between the original and predicted style tokens. In this way, a style subnetwork in accordance with a variety of embodiments of the invention can be trained to generate tokens and spectrograms in a consistent manner, such that a predicted spectrogram generated from a style token of a source spectrogram will produce a predicted style token similar to the style token of the source spectrogram.

### Attention Loss

In a variety of embodiments, custom loss targets can be used to train an audio data generation engine. Custom loss targets in accordance with many embodiments of the invention can be used to bias attention to be roughly linear between the length of the text sequence and a mel sequence. In certain embodiments, text sequences can be encoded into vectors of text features. Audio that has been generated up to a particular point in time can be encoded into a vector of uttered acoustic features. Attention mechanisms in accordance with various embodiments of the invention can be used to learn an alignment between the text features that have been spoken and the linguistic features present in the output thus far.

In several embodiments, attention can be used so that a decoder knows what part of an input sequence needs to be generated at a given timestep. For example, in “hello how are you” if the audio features for “hello how” have been detected, the attention mechanism in accordance with some embodiments of the invention can signal to the decoder that “are” should be uttered next. In order to represent each phoneme in the input sequence of phonemes in the same order in the output sequence of mel frames, processes in accordance with some embodiments of the invention can enforce that the attention function is monotonic in its mapping of phonemes to mels.

To calculate the attention, text encoders in accordance with many embodiments of the invention can take an input sequence of phonemes and produce vectors K, V (for keys and values respectively). In several embodiments, uttered audio can converted by an audio encoder into vector Q (for queries). In numerous embodiments, attention matrix A can then be a multiplication of the Q and K vectors, as a query yielding a key. Attention can then applied by multiplying A and V, or retrieving values for given keys. These values can then be fed into an audio decoder to signal which frames to generate next. In order to make the attention a monotonic function, processes in accordance with numerous embodiments of the invention can add an additional loss target that penalizes attention values that deviate far from an approximately diagonal matrix. At inference time, an attention matrix can be forced to be monotonic by manually zeroing out all regions of the attention matrix other than the desired diagonal entry (set to 1). In certain embodiments, such a loss target is approximate, the exact number of mel frames that a given phoneme will be represented in is unknown.

As a result the approximate loss target has a small penalty when deviations from the diagonal are small (might be a valid deviation) but are harsh when attention appear far from the diagonal (clear misfire). This is manifested by having an attention loss matrix where values deviating away from the diagonal increase according to a Gaussian function.

In several embodiments, knowledge distillation can be incorporated into attention loss to improve the stability of the attention. In knowledge distillation, a teacher can be trained until convergence using the approximate attention loss described above. After convergence, the attention from the teacher model can be smoothed of any glitches, and this attention can then be treated as ground truth. Students of such a teacher can be trained using this as the exact attention loss target.

Distilling the exact knowledge from the teacher allows the model to converge significantly faster and yields a more stable attention. This becomes apparent as it has far fewer stutters, mumbles and “broken record” repeats than models without it.

### ASR Loss

In several embodiments, an automatic speech recognition (ASR) loss can be used to train an audio data generation engine. ASR losses in accordance with various embodiments of the invention can be based on a loss between recognized speech (such as, but not limited to, from a speech to text process) of an original sample and of a generated sample. In numerous embodiments, an ASR subnet can be added to reverse a later layer of the stack back into some linguistic or text features. For example, a spectrogram can be generated based on a source text. The generated spectrogram can then be processed to recognize text, which can then be compared to the source text to determine a loss.

### Adversarial Loss

In certain embodiments, adversarial losses can be used to train an audio data generation engine. Adversarial losses in accordance with a number of embodiments of the invention can try to discern if generated audio data was a ground truth sample or generated. Such an adversarial loss can enforce “realness” constraints on the audio data.

### Spectrogram Loss

In some embodiments, spectrogram losses can be used to train an audio data generation element. Spectrogram losses in accordance with many embodiments of the invention can be computed based on differences between a generated spectrogram (e.g., based on a set of input text and an input voice speaking a different text) and a true sample of the voice speaking the input text.

### Inference

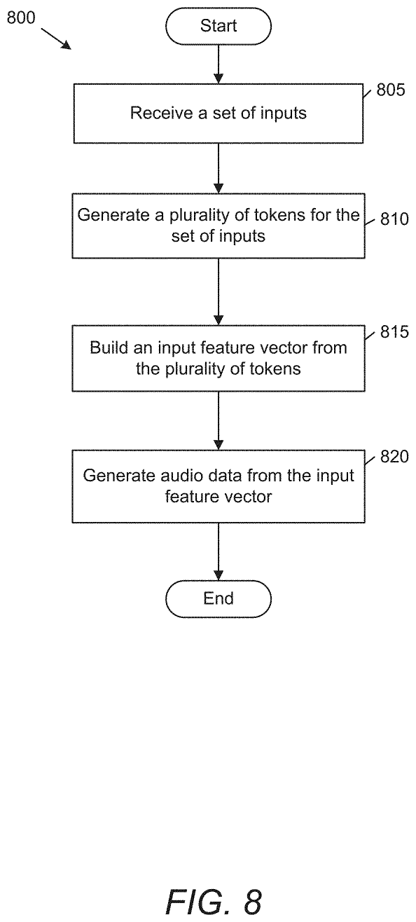

Processes for inference to generate speech using a speech generation framework in accordance with an embodiment of the invention are conceptually illustrated in FIGS. 8-11. An example of a process for generating audio data in accordance with an embodiment of the invention is illustrated in FIG. 8. Process 800 receives (805) a set of inputs. Inputs in accordance with numerous embodiments of the invention can include audio samples, text, phonemes, and other text features. Process 800 generates (810) multiple tokens using multiple different subnetworks. Subnetworks in accordance with various embodiments of the invention can include speaker and/or prosody networks for identifying various characteristics of an audio input. Process 800 builds (815) an input feature vector from the generated tokens. In a number of embodiments, input feature vectors can include other information from the text features, such as raw text, phonemes, etc. Process 800 then generates (820) audio data from the input feature vector. Generated audio data in accordance with some embodiments of the invention can be mel spectrograms, which are attuned to human hearing. In some embodiments, generating the audio data can be performed using a CNN and/or a student teacher network. In a variety of embodiments, processes can generate audio waveforms from generated spectrograms.

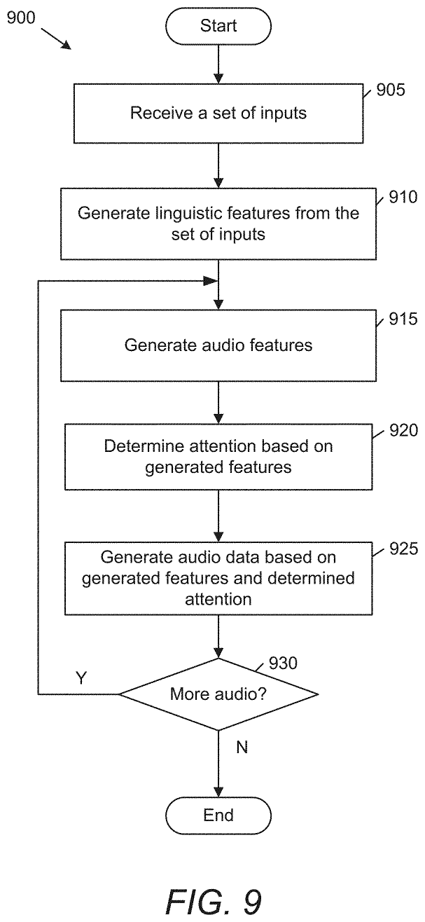

Generating audio data in accordance with a variety of embodiments of the invention can be performed in a number of different ways. An example of a process for autoregressively generating audio data in accordance with an embodiment of the invention is illustrated in FIG. 9. Process 900 receives (905) a set of inputs. Inputs in accordance with several embodiments of the invention can include various text features, such as (but not limited to) text, phonemes, text encodings, etc. Process 900 generates (910) linguistic features from the set of inputs. Linguistic features in accordance with some embodiments of the invention can include encodings of the text features, such as after processing through a trained machine learning model. In a number of embodiments, linguistic features can encode various characteristics of the input text, including (but not limited to) style, speaker, sequence, meaning, etc.

Process 900 generates (915) audio features. Audio features in accordance with numerous embodiments of the invention can include encodings of audio. In a variety of embodiments, audio encodings can include encodings of previously generated audio data that can be used for generating subsequent audio data. In a variety of embodiments, audio features are approximated based on the set of inputs. Process 900 determines (920) attention based on generated features. In certain embodiments, attention can be used to determine how strongly each portion of the input text features correlates with a set of one or more frames of the output. Attention in accordance with certain embodiments of the invention can be used to focus the effects of a portion of the input text features on a portion of the audio data that is to be generated. Process 900 generates (925) audio data based on generated features and determined attention. Process 900 determines (930) whether there is more audio to be generated. When the process determines (930) that there is more audio to generate, the process returns to step 915 and generates audio features from the newly generated audio data. When the process determines (930) there is no more audio to generate, the process ends.

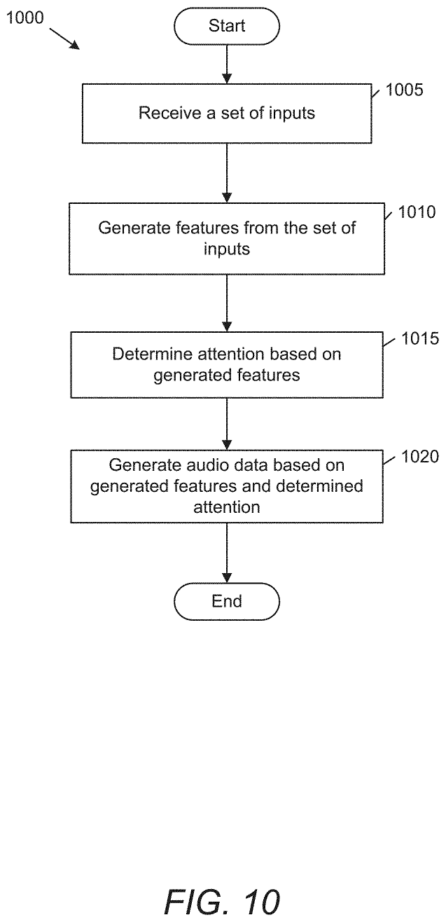

An example of a process for generating audio data in a non-autoregressive manner in accordance with an embodiment of the invention is illustrated in FIG. 10. Process 1000 receives (1005) a set of inputs. Process 1000 generates (1010) features from the set of inputs. In some embodiments, the generated features can include key, value, and/or query features that are all generated directly from the set of inputs. Process 1000 determines (1015) attention based on the generated features. In various embodiments, an approximation of attention is determined based only on the input text. Attention in accordance with certain embodiments of the invention can be used to focus the effect of the entire input text feature on the whole of the audio data to be generated. Process 1000 generates (1020) audio data based on generated features and the determined attention.

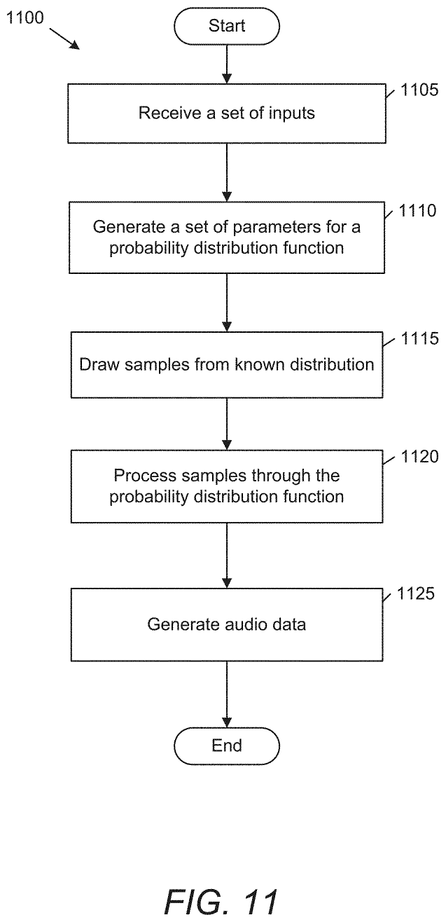

An example of a process for generating audio data using a student-teacher network in accordance with an embodiment of the invention is conceptually illustrated in FIG. 11. Process 1100 receives (1105) a set of inputs. Inputs in accordance with numerous embodiments of the invention can include audio samples and other text features. Process 1100 generates (1110) a set of parameters for a probability distribution function. Parameters in accordance with a variety of embodiments of the invention can be learned from a teacher subnetwork, which is trained on a set of training data. Process 1100 draws (1115) samples from a known distribution and processes (1120) the samples through the parameterized probability distribution function to generate (1125) a spectrogram. In this manner, spectrograms can be generated in a one-shot process in accordance with numerous embodiments of the invention.

While specific processes for generating audio data are described above, any of a variety of processes can be utilized to generate audio data as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although many of the examples herein are described with reference to generating speech, one skilled in the art will recognize that similar systems and methods can be used in a variety of applications, including (but not limited to) other types of audio generation, without departing from this invention.

### Systems for Speech Generation

### System

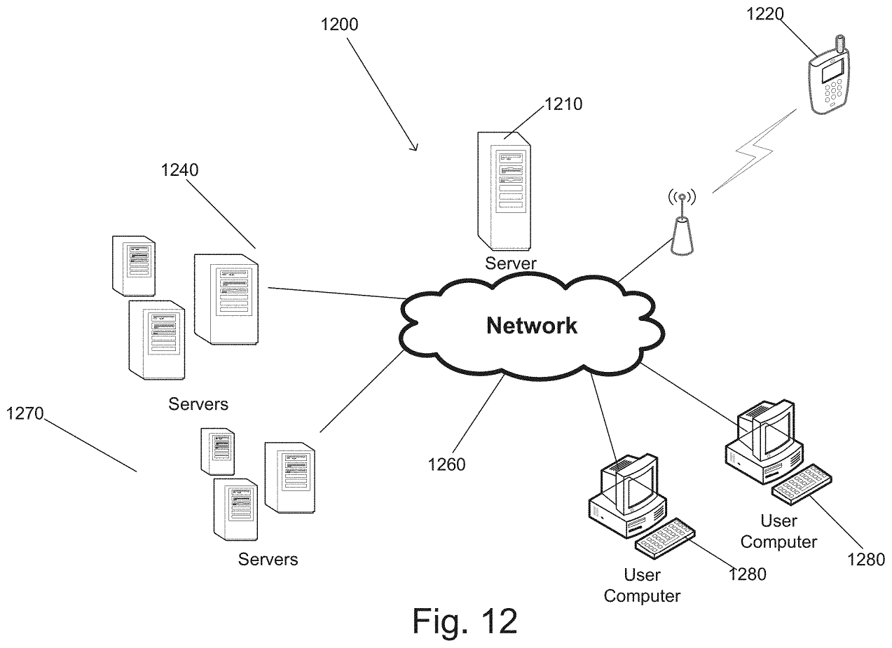

An example of a system that that generates speech in accordance with some embodiments of the invention is shown in FIG. 12. Network 1200 includes a communications network 1260. The communications network 1260 is a network such as the Internet that allows devices connected to the network 1260 to communicate with other connected devices. Server systems 1210, 1240, and 1270 are connected to the network 1260. Each of the server systems 1210, 1240, and 1270 is a group of one or more servers communicatively connected to one another via internal networks that execute processes that provide cloud services to users over the network 1260. For purposes of this discussion, cloud services are one or more applications that are executed by one or more server systems to provide data and/or executable applications to devices over a network. The server systems 1210, 1240, and 1270 are shown each having three servers in the internal network. However, the server systems 1210, 1240 and 1270 may include any number of servers and any additional number of server systems may be connected to the network 1260 to provide cloud services. In accordance with various embodiments of this invention, systems and methods that can be used to generate speech in accordance with an embodiment of the invention may be provided by a process being executed on a single server system and/or a group of server systems communicating over network 1260.

Users may use personal devices 1280 and 1220 that connect to the network 1260 to perform processes for training and/or utilizing a system that can generate speech in accordance with various embodiments of the invention. In the shown embodiment, the personal devices 1280 are shown as desktop computers that are connected via a conventional “wired” connection to the network 1260. However, the personal device 1280 may be a desktop computer, a laptop computer, a smart television, an entertainment gaming console, or any other device that connects to the network 1260 via a “wired” connection. The mobile device 1220 connects to network 1260 using a wireless connection. A wireless connection is a connection that uses Radio Frequency (RF) signals, Infrared signals, or any other form of wireless signaling to connect to the network 1260. In FIG. 12, the mobile device 1220 is a mobile telephone. However, mobile device 1220 may be a mobile phone, Personal Digital Assistant (PDA), a tablet, a smartphone, or any other type of device that connects to network 1260 via wireless connection without departing from this invention.

As can readily be appreciated the specific computing system used to generate speech is largely dependent upon the requirements of a given application and should not be considered as limited to any specific computing system(s) implementation. While specific implementations of speech generation have been described above with respect to FIG. 12, one skilled in the art will recognize that various different configurations of speech generation systems can be utilized as appropriate to the requirements of a given application.

### Speech Generation Element

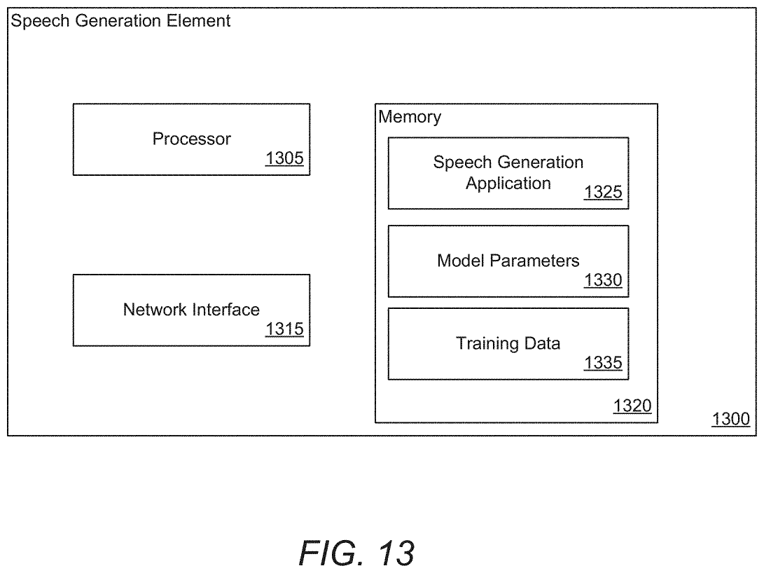

An example of a speech generation element that generates speech and/or voices in accordance with various embodiments of the invention is shown in FIG. 13. Speech generation elements in accordance with many embodiments of the invention can include (but are not limited to) one or more of mobile devices, servers, cloud services, and computers. Speech generation element 1300 includes processor 1305, network interface 1315, and memory 1320.

One skilled in the art will recognize that a particular speech generation element may include other components that are omitted for brevity without departing from this invention. For example, speech generation elements in accordance with a variety of embodiments of the invention can include an audio collection element for gathering speech samples (e.g., directly through a microphone, from a local storage, or over a network) and/or an audio output for vocalizing generated speech. The processor 1305 can include (but is not limited to) a processor, microprocessor, controller, or a combination of processors, microprocessor, and/or controllers that performs instructions stored in the memory 1320 to manipulate data stored in the memory. Processor instructions can configure the processor 1305 to perform processes in accordance with certain embodiments of the invention. Network interface 1315 allows speech generation element 1300 to transmit and receive data over a network based upon the instructions performed by processor 1305.

Memory 1320 includes a speech generation application 1325, model parameters 1330, and training data 1335. Speech generation applications in accordance with several embodiments of the invention can be used to train a speech generation model and/or to generate speech from a set of inputs, such as (but not limited to) text inputs, audio inputs, and/or style inputs. Speech generation applications in accordance with numerous embodiments of the invention can be a component of another application, where speech generation applications can be used to provide outputs for a user interface of the application. In a number of embodiments, speech generation applications can implement speech generation frameworks, such as those described in the example of FIG. 1.

Although a specific example of a speech generation element 1300 is illustrated in FIG. 13, any of a variety of speech generation elements can be utilized to perform processes similar to those described herein as appropriate to the requirements of specific applications in accordance with embodiments of the invention.

Although specific methods of audio data generation are discussed above, many different methods of generating audio can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for generating audio data, the method comprising:
generating a plurality of style tokens from a set of audio inputs;
generating an input feature vector based on the plurality of style tokens and a set of text features; and
generating audio data based on the input feature vector.

2. The method of claim 1, wherein generating the plurality of style tokens comprises:
generating a speaker token using a speaker subnetwork; and
generating a prosody token using a prosody subnetwork.

3. The method of claim 2, wherein at least one of the speaker subnetwork and the prosody subnetwork is a pre-trained network.

4. The method of claim 1, wherein the set of audio inputs comprises a set of samples with a desired characteristic, wherein the generated audio data reflects the desired characteristic.

5. The method of claim 1, wherein generating the input feature vector comprises at least one of averaging, concatenating, and adding a subset of the plurality of style tokens.

6. The method of claim 1, wherein the set of text features comprises at least one of raw text, audio data, parts of speech, and phonemes.

7. The method of claim 1, wherein generating the audio data comprises utilizing a convolution neural network (CNN) to generate a spectrogram.

8. The method of claim 1, wherein generating the audio data comprises utilizing teacher and student networks to generate the audio data.

9. The method of claim 8, wherein generating the audio data comprises:
training the teacher network to generate audio data in an autoregressive manner; and
training the student network to learn from the teacher network to generate audio data in a non-autoregressive manner.

10. The method of claim 9, wherein training the student network comprises training the student network to learn to predict attention from the set of audio inputs, wherein the student network generates the audio data using the predicted attention.

11. The method of claim 1, wherein the generated audio data is a mel spectrogram.

12. The method of claim 11, wherein the method further comprises generating audio waveforms from the generated spectrogram.

13. A non-transitory machine readable medium containing processor instructions for generating audio data, where execution of the instructions by a processor causes the processor to perform a process that comprises:
generating a plurality of style tokens from a set of audio inputs;
generating an input feature vector based on the plurality of style tokens and a set of text features; and
generating audio data based on the input feature vector.

14. The non-transitory machine readable medium of claim 13, wherein generating the plurality of style tokens comprises:
generating a speaker token using a speaker subnetwork; and
generating a prosody token using a prosody subnetwork.

15. The non-transitory machine readable medium of claim 13, wherein the set of audio inputs comprises a set of samples with a desired characteristic, wherein the generated audio data reflects the desired characteristic.

16. The non-transitory machine readable medium of claim 13, wherein generating the input feature vector comprises at least one of averaging, concatenating, and adding a subset of the plurality of style tokens.

17. The non-transitory machine readable medium of claim 13, wherein the set of text features comprises at least one of raw text, audio data, parts of speech, and phonemes.

18. The non-transitory machine readable medium of claim 13, wherein generating the audio data comprises utilizing a convolution neural network (CNN) to generate a spectrogram.

19. The non-transitory machine readable medium of claim 13, wherein generating the audio data comprises utilizing teacher and student networks to generate the audio data, wherein generating the audio data comprises:
training the teacher network to generate audio data in an autoregressive manner; and
training the student network to learn from the teacher network to generate audio data in a non-autoregressive manner.

20. The non-transitory machine readable medium of claim 9, wherein training the student network comprises training the student network to learn to predict attention from the set of audio inputs, wherein the student network generates the audio data using the predicted attention.
